(19) United States
(12) Patent Application Publication
(10) Pub. No.: US 2005/0128949 A1
(43) Pub. Date: Jun. 16, 2005

(54) NETWORK SYSTEM HAVING A PLURALITY OF SWITCHES CAPABLE OF IMPROVING TRANSMISSION EFFICIENCY AND METHOD THEREOF

(76) Inventors: Hau-Chun Ku, Taipei Hsien (TW); Weipin Chen, Taipei Hsien (TW); Ruth Lin, Taipei Hsien (TW); ChaoCheng Cheng, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/905,017

(22) Filed: Dec. 9, 2004

Related U.S. Application Data
(60) Provisional application No. 60/481,778, filed on Dec. 12, 2003.

(51) Int. Cl. H04L 12/28; H04L 12/54; H04L 12/56

(52) U.S. Cl. 370/235; 370/386; 370/428; 370/415

(57) ABSTRACT

A network system includes a plurality of switches for controlling data packet transmission within the network, and a central processor coupled to the plurality of switches for sending at least one adjusting signal to at least one of the plurality of switches to adjust its processing manner for data packets.

### CROSS REFERENCE TO RELATED APPLICATIONS

This application claims the benefit of U.S. Provisional Application No. 60/481,778, filed Dec. 12, 2003, and included herein by reference.

### BACKGROUND OF INVENTION

1. Field of the Invention

The present invention relates to a network system and related method, more particularly, to a network system and related method for utilizing a central processor to adjust switches to control data packet transmission in the network system.

2. Description of the Prior Art

As network applications flourish, personal users and companies rely more and more on networks today, especially Ethernet. The International Organization for Standardization (ISO) provides an open system interconnect mode (OSI) which can be accessed by the public. Standard network transmission uses a common mode in which there are seven levels of communication. The seven levels allow correspondence such as transmission, receiving and interruption, between two systems to be better managed. Since they are well-known to those skilled in the art, the functions and usage of OSI will not be further mentioned here.

Before the transmission of data, the data is first divided into packets, and these packets are tagged with header information used for controlling the packet transmission. Please refer to FIG. 1. FIG. 1 illustrates a diagram of a data link layer of a packet 10. The data link layer belongs to level 2 of the OSI, which is a level that a switch normally acts on. The data link layer of the packet 10 comprises a preamble field, a destination field, a source field, a type field, data field, and a frame check sequence field. Among these the preamble field provides information such as marking the beginning of the data packet, identifying synchronized message, decoding, etc. The destination field stores an end address of the data packet, and the source field stores a transmission of the address; both the destination field and the source field also store a medium access control (MAC) address. The type field stores a protocol (for example, IP protocol), the data field stores data content of the packet, and lastly the frame check sequence field allocates a check bit for a cyclic redundancy check (CRC).

Please refer to FIG. 2. FIG. 2 illustrates a prior art diagram of a regional network 20. The regional network 20 comprises a plurality of switches 22. Each switch 22 couples to a plurality of clients 24, other switches 22 or other network exchange equipment such as a bridge, a hub or a repeater that are used in layers below the data link layer of the network equipment. In the regional network 20, which can range from tens to hundreds of clients 24 connecting to the regional network 20 at the same time, in order to ensure the speed of the regional network 20, the switch 22 handles a high number of signals and functions needed for network management. As the switch operates at the level 2 data link layer of the OSI, when the data is divided into packets, the switch using point-to-point mode allocates the packet to the destination according to the MAC address (which is the destination field of FIG. 1). The switch at the same time can have many connectors 26 for parallel transmissions. In this way, a chance of collision is lowered and also bandwidth is put to full use, and hence, the efficiency of the whole network is increased. For example, if a switch has ten connectors 26 and uses a 10 BASE T transmission cable, the bandwidth of each connector 26 is 10 Mbps.

There is another network equipment known as a router. The main function of the router is to perform a connection between a regional network and another regional network, which works differently from the switch in communication between clients in a network. The router is capable of selecting a suitable path for packet transmission. The router determines a best path through setting up a routing table, and a related address is created for the router to refer to in order to seek the best suitable path. Each router will automatically detect the information and create a communicating routing table to display the network situation of each channel, whether the channel is congested or interrupted, to create the best path for the data packet for ensuring transmission flow.

Although the router is capable of seeking the shortest path, it only functions at the third network layer of the OSI. A normal IP protocol belongs to the network layer protocol, and only an IP address above the network layer serves a purpose; addresses below the network layer are verified by the MAC address. In processing the packets, the router does not verify transmission addresses directly through the MAC address like the switch does, but rather through an address resolution protocol (ARP) that changes the IP protocol into a protocol of the MAC address, in order to know where each layer under the network layer sends the data to, or by using reverse address resolution protocol (RARP) for using the ARP to seek the IP address from the MAC address. In this way, cost and complexity of the router is high, and under commercial considerations the router cannot replace the switch or the hub.

In a regional network, there are different types of data transmission schemes. For clients receiving online movies or online broadcasting, the data packet transmission requires an emphasis on smooth high-speed transmission. As for program file transmission, a completed transmission is required in order to open the program file, hence the data packet transmission puts emphasis on the accuracy of transmission. Those skilled in the art will recognize that the switch is unable to differentiate whether the data packet transmission requires an accurate transmission or time efficient transmission, and in a busy network, this type of architecture may easily cause interruption or congestion. Furthermore, those skilled in the art will know that the router has a function that seeks the shortest path. However in a traditional network architecture, the router acts as a bridge between a regional network and another regional network. In a regional network, the switch cannot find the best possible transmission like the router, therefore in a network that uses a switch, the data transmission switch acting as an intermediate device is not able to select the best possible transmission path. Therefore a goal of the industry is to utilize a switch to quickly find a best transmission path in order to control packet transmission.

### SUMMARY OF INVENTION

The present invention relates to a network system capable of utilizing a central processor to control the mode of processing data packets of some switches inside the network system in order to control bandwidth usage of the network system more efficiently according to magnitude of data flow of a switch and properties of a data packet in a network.

One preferred embodiment of the claimed invention relates to a network system capable of utilizing a central processor for controlling a plurality of switches, the network system comprising: a plurality of switches for controlling transmission of data packets in a network system; and a central processor, coupled to the plurality of switches, for transmitting at least an adjusting signal to at least a switch of the plurality of switches to adjust the mode of processing the data packets.

One preferred embodiment of the claimed invention further comprises a method of managing a network system, the method comprising the following steps: coupling a central processor to a plurality of switches; and the central processor transmitting at least an adjusting signal to at least a switch of the plurality of switches to adjust the mode of processing the data packets.

One preferred embodiment of the claimed invention further comprises a method of managing a network system, the method comprises the following steps: coupling a central processor to a plurality of switches; the central processor assigning at least one switch from a plurality of switches to form a transmission path for transmitting the data packets from a transmitting client to a receiving client; and the central processor transmitting at least an adjusting signal to at least one switch of the transmission path to adjust the mode of processing the data packets.

The present invention, during operation of the network, utilizes a central processor to detect the data flow of each switch in the network and the properties of data packet transmission to adjust the operation of each switch in the network. For example, when an overflowed switch is discovered, the setting of other surrounding switches is adjusted not to transmit through the overflowed switch which has high volume flow. For example, according to the content of transmits file or according to the demands of users, the mode of transmission of part of the switch is adjusted to select the mode of data packet transmission according to transmission properties of the data packet. In general, for example, when the high-speed transmission requirement is needed, connected switches are adjusted to use the cut-through mode, and when the high-accuracy transmission requirement is needed, then the switches are adjusted to use the store-and-forward mode transmission path. For example, when a particular switch transmits a particular data packet to another particular switch, a plurality of switches are selected, and then the input ports and output ports of these switches are adjusted to form a specific transmission path connecting the two particular switches. Also, the mode of transmission of each switch on the transmission path could also be adjusted. Hence during the operation of the network, the data packet not only is capable of transmitting on the specific transmission path, but the switches on the transmission path are able to select a transmission mode to adjust the operation of the network system according to the transmission properties of the received data packet.

In the present invention, the central processor not only is capable of selecting parts of the switch to form a specific path to transmit data packets, but simultaneously, is capable of adjusting parts of the switch to change the mode of data packet transmission according to the content of the data packet. In this way, if part of the switch does not function well or some switches in the network are congested, the central processor is capable of maintaining the normal data transmission in the operation of the network by utilizing other switches. The central processor is also capable of adjusting the processing manner for data packets to increase elasticity of the switches.

These and other subject matter of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a diagram of a data link layer of a packet.

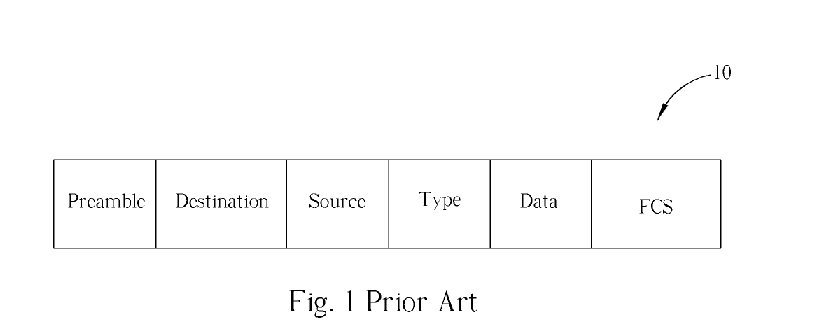

FIG. 2 illustrates a diagram of an architecture of regional network.

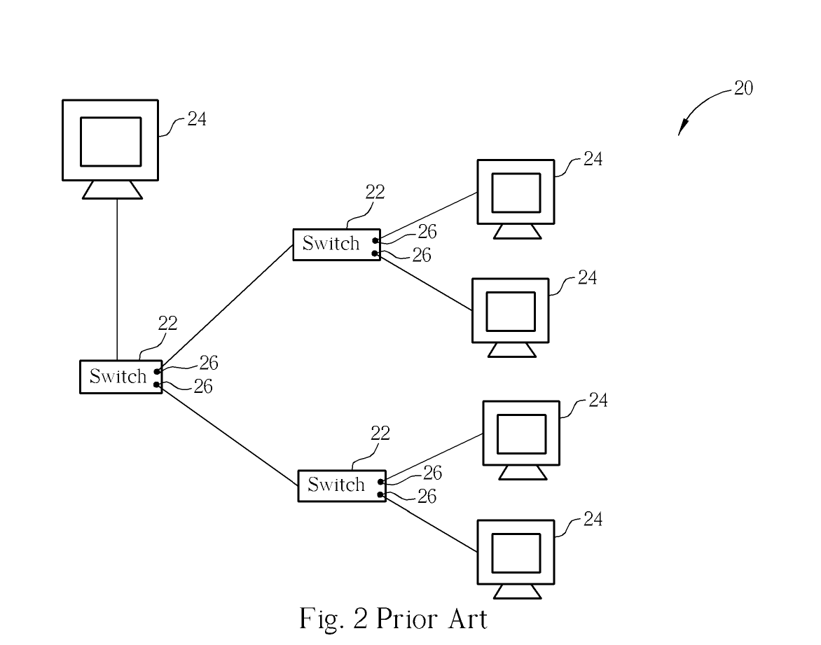

FIG. 3 is a functional block diagram of switches and clients in architecture of Ethernet.

### DETAILED DESCRIPTION

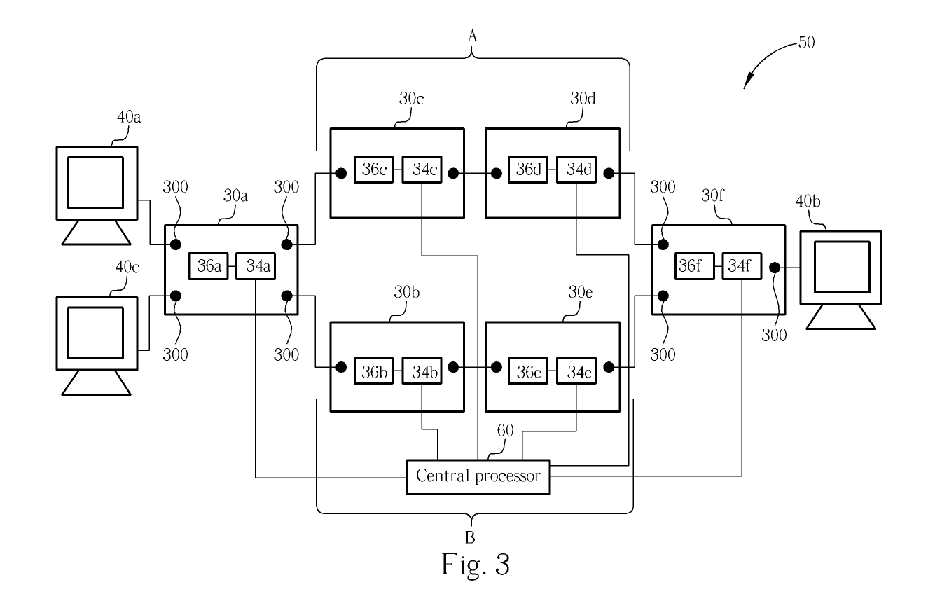

Please refer to FIG. 3. FIG. 3 is a functional block diagram of central processor 60 and switches 30a-30f, according to the present invention, coupled to clients in an Ethernet 50 architecture. The central processor 60 couples to the switches 30a-30f, and the switch 30a-30f comprises a logic unit 34a-34f, a buffer 36a-36f and a plurality of connectors (input port and output port) 300. A typical Ethernet 50 comprises a plurality of clients, and the switches are coupled in between the clients (FIG. 3 shows 3 clients 40a-40c and 6 switches 30a-30f). The central processor 60 will detect the data flow of switches 30a-30f and control the switches 30a-30f to process data packets and also the mode of data transmission. In a plurality of connectors 300, some are used for receiving a data packet (which like the input ports), and others are used for outputting a data packet (which like the output port). When the data packet from the input port is transmitted to every switch 30a-30f, the data will be temporarily stored in the corresponding buffer 36a-36f, to be further processed by the logic unit. Structure of the logic unit 34a-34f can be used to record the mode of each output port of other switches (or clients), to analyze the data packets of hardware/firmware, or to decide which output port to output according to the data analyzed and data stored in the memory.

The central processor 60 detects the magnitude of data flow of the switches 30a-30f. When magnitude of data flow of a switch exceeds a predetermined value, it means that the switch may be required to process a high volume of data packets, and this causes the efficiency of at least one output port of the switch to slow down. The central processor 60 is able to adjust the switch and uses a faster mode of processing data packets (such as the cut through mode, this mode will be explained later), or to use other output ports of the same switch that has a lesser data flow to output the data packet. The central processor 60 is also able to adjust the input port and the output port of the switches surrounding the switch suffering from data overflow to reduce and avoid data packets being transmitted to the overflowed switch from the surrounding switches. The above-mentioned predetermined value can be variable.

Now, those skilled in the art will know that there are two types of modes for processing packets: one is a cut through mode; and the other is a store and forward mode. When the switch receives a data packet, the preamble field and the destination field of the data packet are then stored into the buffer and then the data packet is transmitted through the output port, hence there is no need to store every field of the data packet into the buffer or to transmit every field. This type of transmission mode of checking part of the field is known as the cut through mode. For the other mode, when the switch receives a data packet, every field of the data packet is first stored into the buffer and the data packet is then checked completely before sending out, this type of transmission mode is known as the store and forward mode. It is obvious that the cut through mode does not check for completeness, and therefore accuracy is low but transmission speed is faster this way; as for the store and forward mode, the data packet is required to be checked for completeness, and therefore processing time is longer and the transmission speed is slower.

In order to have a better understanding of the operation, please refer to FIG. 3. If the switch 30f initially uses a store and forward mode to process data packets, but as there are too many packets coming from the switches 30d, 30e, this will cause the switch 30f to operate at a slower speed when processing the data packets to be sent to the client 40b. At this time, the central processor 60 is able to send out an adjusting signal to change the internal setting of the logic unit 34f of the switch 30f to change from the store and forward mode to a cut through mode, which also means that after the preamble field and the destination field are stored into the buffer 36f, the data packet is sent out through the output port to the client 40b, and the accuracy of the packets are not checked in order to reduce the time which the data packet stays at the switch 30f.

In another example, suppose the switches 30c, 30d use the cut through mode, and the switches 30b, 30e use the store and forward mode. Under normal circumstances, the transmission speed of switches 30c, 30d transmitting through channel A is faster than the transmission speed of switches 30b, 30e transmitting through channel B. When the switch 30a receives a data packet, the central processor 60 will detect that the transmission speed of channel A is faster than channel B, and the central processor 60 will select channel A for the switch 30a to transmit the data packet. For example, when the switch 30a receives data packets from the client 40a, 40c, but priority of the data packet from the client 40a is greater than data packet from the client 40c, at this time, the central processor 60 is able to set the switch 30a to transmit the data packet of the client 40a through the channel A and stops the other client (such as client 40c) from using the channel A. Thus for the data packet with a lower priority from client 40c will transmit through the channel B, or to wait until the data flow of the channel A is not as busy before transmitting. Other than that, the central processor 60 can also utilize a particular transmission path to transmit data according to a particular file indicated. If a file from the client 40a is transmitted to the client 40b, the central processor 60 is able to send out an adjusting signal to adjusting units 34a, 34c, 34d, 34f of the switches 30a, 30c, 30d, 30f to process the mode of transmission on whether to use the store and forward mode or the cut through mode. Also the adjusting unit is able to stop other clients from using the transmission channel formed by the switches 30a, 30c, 30d, 30f, until the client 40a has completed the transmission of files to the client 40b, and only then can the other client use the transmission channel to transmit data packets.

Besides deciding the mode of processing data packets in the logic unit of the switch according to the data flow, in one preferred embodiment of the claimed invention, the central processor is capable of utilizing the switch to select the mode of processing data packets according to the transmission properties of the data packet. For example, when magnitude of the data flow of a switch exceeds the predetermined value, the central processor can send out an adjusting signal to the logic unit for selecting an output port to transmit data packets according to the transmission properties. In another words, once the central processor detects a high magnitude of data flow on a switch, the switch is able to change the internal setting of the logic unit when receiving a high-speed file (a user datagram protocol (UDP)), such as a multimedia file, using a cut through mode to transmit data packets which reduces the time in which the data packets stay at the switch. Relatively, when the switch receives a high-accuracy file (a transmission control protocol (TCP)), the switch uses a store and forward mode to check for the accuracy and then transmits the data packets. In this way, the magnitude of data flow of the switch changes, and the logic unit is able to adjust to different modes according to the data packet received. If emphasis is placed on time-efficiency, the data packet will be sent out quickly, and if emphasis is placed on accuracy, then the data packet will be checked before sending out, in order to reach the best possible transmission.

Although the above embodiments use one switch as example, the invention can be implemented to the case that every switch of a plurality of switches comprising the above-mentioned functions. Further, the logic unit could determine the priority of the data packets not only according whether the packet utilizes a TCP or UDP but, and also could be according to source or service content to decide the processing mode of the data packet.

In comparison to the prior art, the central processor of the network in the present invention is capable of detecting the magnitude of data flow of each switch in the system and controlling the data flow of each switch or adjusting the mode of processing the data packets of each switch according to the content of the data packet. When an overflowed switch is discovered or if a particular transmission request is received, partial switches of the network can produce a specific transmission path, and simultaneously, the mode of the partial switches are changed to processing the data packets. For every switch, the central processor can change the mode of a switch to the cut-through mode when emphasis is placed on transmitting data packets in a time-efficient manner; when emphasis is place on accuracy, the switch utilizes the store and forward mode to ensure transmission accuracy. The network can also view the emphasis on the data packet to adjust the transmission path of the switches. Through such control mechanism, the network system of the present invention can perform the best network transmission management.

Those skilled in the art will readily observe that numerous modifications and alterations of the device and method may be made while retaining the teachings of the invention. Accordingly, the above disclosure should be construed as limited only by the metes and bounds of the appended claims.

1. A network system capable of controlling a plurality of switches, the network system comprising:
a plurality of switches for controlling transmission of data packets in the network system; and
a central processor, coupled to the plurality of switches, for transmitting at least an adjusting signal to a switch of the plurality of switches to adjust the mode used to process the data packets.

2. The network system of claim 1 wherein the switch comprises:
an input port for receiving a data packet;
a buffer, coupled to the input port, for temporarily storing the data packet received from the input port;
an output port, coupled to the buffer, for outputting the data packet; and
a logic unit, coupled to the buffer and the output port, for selecting the mode of outputting the data packet.

3. The network system of claim 2 wherein the logic unit selects the mode of outputting the data packet according to content of the data packet.

4. The network system of claim 2 wherein the logic unit selects the mode of outputting the data packet according to the magnitude of data flow of the switch.

5. The network system of claim 2 wherein the switch comprises a plurality of output ports, the logic unit selects an output port of the plurality of output ports to output the data packet and selects the mode of outputting the data packet through the buffer and the selected output port.

6. The network system of claim 5 wherein the logic unit selects an output port of the plurality of output ports to output the data packet and selects either a cut through mode or a store and forward mode to output the data packet through the buffer and the output port.

7. The network system of claim 2 wherein the switch comprises a plurality of output ports, the logic unit selects an output port of the plurality of output ports to output the data packet.

8. The network system of claim 2 wherein the logic unit selects the mode of outputting the data packet through the buffer and the output port.

9. The network system of claim 8 wherein the logic unit selects either a cut through mode or a store and forward mode to output the data packet through the buffer and the output port.

10. A method of managing a network system, the method comprising the following steps:
(a) coupling a central processor to a plurality of switches; and
(b) the central processor transmitting at least an adjusting signal to a switch of the plurality of switches to adjust the mode of processing the data packets.

11. The method of claim 10 wherein step (b) utilizes the central processor to control the mode of data packet transmission of a switch according to content setting of the data packet.

12. The method of claim 10 wherein step (b) utilizes the central processor to control the mode of data packet transmission of a switch according to magnitude of data flow setting of the switch.

13. The method of claim 10 wherein step (b) utilizes the central processor to control the switch to select an output port of a plurality of output ports to output the data packet and to select the mode of outputting the data packet through the buffer and the selected output port.

14. The method of claim 13 wherein step (b) utilizes the central processor to control the switch to select an output port of the plurality of output ports to output the data packet and to select either a cut through mode or a store and forward mode to output the data packet through the buffer and the output port.

15. The method of claim 10 wherein step (b) utilizes the central processor to control the switch to select an output port of a plurality of output ports to output the data packet according to content of data packet.

16. The method of claim 10 wherein step (b) utilizes the central processor to control a switch to select the mode of outputting the data packet through the buffer and the selected output port according to content of the data packet.

17. The method of claim 16 wherein step (b) utilizes the central processor to control the switch to select either a cut through mode or a store and forward mode to output the data packet through the buffer and the output port according to content of the data packet.

18. The method of claim 10 wherein in step (b) when magnitude of data flow of the switch exceeds a predetermined value, the central processor controls a cut through mode of data packet transmission of the switch according to data flow setting of the switch.

19. The method of claim 10 wherein in step (b) when magnitude of data flow of the switch exceeds a predetermined value, the central processor controls surrounding switches connected to the switch to reduce the probability of using any output port of the surrounding switches, thereby reducing the magnitude of data flow to the switch that exceeds the predetermined value.

20. A method of managing a network system, the method comprising the following steps:
(a) coupling a central processor to a plurality of switches;
(b) the central processor assigning at least one switch from the plurality of switches to form a transmission path for transmitting a data packets from a transmitting client to a receiving client; and
(c) the central processor transmitting at lest one adjusting signal to the switches of the transmission path to adjust the mode of processing the data packets.

21. The method of claim 20 wherein step (c) utilizes the central processor to set the mode of at least one assigned switch for transmitting the data packet of the switch of the transmission path to either a cut through mode or a store and forward mode.

22. The method of claim 20 wherein step (c) comprises utilizing the central processor to control at least one of the switches of the transmission path not to receive data packets from other switches that are not on the transmission path until transmission is completed from the transmitting client to the receiving client.
